(19) United States
(12) Patent Application Publication
(10) Pub. No.: US 2011/0250114 A1
(43) Pub. Date: Oct. 13, 2011

(54) Vanadia-Based DeNOx Catalysts and Catalyst Supports

(75) Inventors: Steve M. Augustine, Ellicott City, MD (US); Modasser El-Shoubary, Crofton, MD (US); Dennis Clark, Catonsville, MD (US)

(73) Assignee: Millennium Inorganic Chemicals, Inc.

(21) Appl. No.: 12/759,392

(22) Filed: Apr. 13, 2010

(51) Int. Cl. B01D 53/56; B01J 27/199; B01J 27/192; B01J 27/19

(52) U.S. Cl. 423/239.1; 502/211; 502/209; 502/212

(57) ABSTRACT

A vanadia-based catalytic composition for reduction of nitrogen oxides includes a titania-based support material; vanadia deposited on the titania-based support material; a primary promoter comprising tungsten oxide, molybdenum oxide or combinations thereof; and an amount of phosphate to achieve a mole ratio of phosphorus to vanadium plus molybdenum of about 0.2:1 or greater. A zirconia, tin or manganese oxide can be added to further inhibit the volatility of molybdenum. Results show low SO₂ oxidation rates and excellent NOₓ conversion and/or molybdenum stability.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of Invention

The presently claimed and disclosed inventive concept(s) relates generally to catalysts and methods of making catalysts and, more particularly, but not by way of limitation, to catalysts and methods of making catalysts that are useful for purifying exhaust gases and waste gases from combustion processes.

2. Background of the Invention

The high temperature combustion of fossil fuels or coal in the presence of oxygen leads to the production of unwanted nitrogen oxides (NOₓ). Significant research and commercial efforts have sought to prevent the production of these well-known pollutants, or to remove these materials, prior to their release into the air. Additionally, federal legislation has imposed increasingly more stringent requirements to reduce the amount of nitrogen oxides released to the atmosphere.

Processes for the removal of NOₓ formed in combustion exit gases are well-known in the art. The selective catalytic reduction (SCR) process is particularly effective. In this process, nitrogen oxides are reduced by ammonia (or another reducing agent such as unburned hydrocarbons present in the waste gas effluent) in the presence of oxygen and a catalyst to form nitrogen and water. The SCR process is widely used in the U.S., Japan, and Europe to reduce emissions of large utility boilers and other commercial applications. Increasingly, SCR processes are being used to reduce emissions in mobile applications such as in large diesel engines like those found on ships, diesel locomotives, automobiles, and the like.

Effective SCR DeNOₓ catalysts include a variety of mixed metal oxide catalysts, including vanadium oxide supported on an anatase form of titanium dioxide (see, for example, U.S. Pat. No. 4,048,112) and titania with an oxide of molybdenum, tungsten, iron, vanadium, nickel, cobalt, copper, chromium or uranium (see, for example, U.S. Pat. No. 4,085,193).

Vanadium and tungsten oxides supported on titania have been standard catalyst compositions for NOₓ reduction since its discovery in the 1970's. In fact, very few alternatives rival the catalytic performance of vanadium and tungsten oxides supported on titania. Tungsten is an important element in DeNOₓ catalyst applications, both mobile and stationary, to improve conversion and selectivity of titania-supported vanadia catalysts. However, world markets have seen a sharp increase in its cost, creating incentive to reduce the amount of tungsten used in DeNOₓ catalyst materials. Recent efforts have resulted in reducing tungsten in commercial catalysts from 8% W to 4% W by weight. However, below these levels, the catalyst performance begins to fall beneath acceptable ranges.

A particularly effective catalyst for the selective catalytic reduction of NOₓ is a metal oxide catalyst comprising titanium dioxide, divanadium pentoxide, and tungsten trioxide and/or molybdenum trioxide (U.S. Pat. No. 3,279,884). Also, U.S. Pat. No. 7,491,676 teaches a method of producing an improved catalyst made of titanium dioxide, vanadium oxide and a supported metal oxide, wherein the titania-supported metal oxide has an isoelectric point of less than or equal to a pH of 3.75 prior to depositing the vanadium oxide.

It is also known in the art that iron supported on titanium dioxide is an effective selective catalytic reduction DeNOₓ catalyst (see, for example, U.S. Pat. No. 4,085,193). However, the limitations to using iron are its lower relative activity and higher rate of oxidation of sulfur dioxide to sulfur trioxide (see, for example, Canadian Patent No. 2,496,861). Another alternative being proposed is the use of transition metals supported on beta zeolites (see for example, U.S Pat. Appl. Pub. No. 2006/0029535). The limitation of this technology is the high cost of zeolite catalysts, which can be a factor of 10 greater than comparable titania-supported catalysts.

Molybdenum-containing catalyst systems are well documented in the prior art; however, the use of molybdenum as a commercial catalyst is hampered by two factors. The first factor is the relative volatility of the hydrous metal oxide compared to tungsten counterparts leading to molybdenum losses under commercial conditions. The second factor is the relatively higher SO₂ oxidation rate compared to tungsten-containing systems. SO₂ oxidation is a problem in stationary DeNOₓ applications due to the formation of ammonium sulfate which causes plugging and excessive pressure drops in process equipment. The presently claimed and disclosed inventive concept(s) are directed to an improved molybdenum-containing catalyst to address these issues.

### SUMMARY OF THE INVENTION

The presently claimed and disclosed inventive concept(s) is directed to a titania-based catalyst support material. In addition to titania, the support material includes a primary promoter comprising tungsten oxide and/or molybdenum oxide and an amount of phosphate to achieve a mole ratio of phosphorus to tungsten plus molybdenum of about 0.2:1 or greater. In one embodiment, the primary promoter contains molybdenum oxide and an amount of phosphate to achieve a mole ratio of phosphorus to tungsten plus molybdenum of about 0.2:1 or greater.

When a molybdenum primary promoter is used, a volatility inhibitor can be added to further improve performance of the catalyst. Suitable volatility inhibitors include, but are not limited to, zirconium oxide, tin oxide, manganese oxide, lanthanum oxide, cobalt oxide, niobium oxide, zinc oxide, bismuth oxide, aluminum oxide, nickel oxide, chromium oxide, iron oxide, yttrium oxide, gallium oxide, germanium oxide, indium oxide, and combinations thereof.

A process for making a titania-based catalyst support material includes the following steps. An aqueous slurry of titania is provided and exposed to a soluble promoter compound. The soluble promoter compound can include tungsten, molybdenum, or a combination of tungsten and molybdenum. A phosphate compound is added in sufficient quantity to achieve a mole ratio of phosphorus to tungsten plus molybdenum of about 0.2:1 or greater, and the pH is adjusted to a value allowing deposition of the promoter and phosphate to yield a phosphated promoter-titania mixture. Water is removed from the phosphated promoter-titania mixture to produce promoter-titania mixture solids which are calcined to produce a titania-based catalyst support material having a mole ratio of phosphorus to tungsten plus molybdenum of about 0.2:1 or greater.

Also embodied is a vanadia-based catalytic composition for reduction of nitrogen oxides. The catalytic composition has a titania-based support material with vanadia deposited on the titania-based support material. The composition includes a primary promoter comprising tungsten oxide and/or molybdenum oxide, and an amount of phosphate to achieve a mole ratio of phosphorus to tungsten plus molybdenum of about 0.2:1 or greater. In one embodiment, the primary promoter is molybdenum oxide and the phosphate is present in an amount to achieve a mole ratio of phosphorus to molybdenum of about 0.2:1 or greater. When both phosphate and the volatility inhibitor are utilized with the molybdenum oxide promoter, the phosphate at a mole ratio of phosphorus to molybdenum of about 0.2:1 or greater, molybdenum retention is greatly improved and SO₂ oxidation is reduced.

A process for making a vanadia-based catalytic composition for reduction of nitrogen oxides includes the following steps. An aqueous slurry of titania is provided and exposed to a soluble promoter compound, wherein the promoter can be molybdenum, tungsten or a combination of molybdenum and tungsten. The pH is adjusted to a value allowing deposition of the molybdenum promoter to yield a hydrolyzed promoter-titania mixture. Water is removed from the hydrolyzed promoter-titania mixture, optionally by filtration and drying, to produce promoter-titania mixture solids. The promoter-titania mixture solids are then calcined to produce a support material, which is added to an aqueous solution of vanadium oxide to produce a product slurry. A phosphate compound is added in sufficient quantity to achieve a mole ratio of phosphorus to promoter (tungsten plus molybdenum) of about 0.2:1 or greater in the product slurry. The phosphate compound can be added during support preparation, such as to the hydrolyzed promoter-titania mixture prior to water removal. Optionally, the phosphate can be added during deposition of the active phase, such as directly after addition of the aqueous solution of vanadium oxide to the support material. In either case, water is removed from the product slurry to produce product solids that are calcined to form a vanadia-based catalytic composition for reduction of nitrogen oxides, the vanadia-based catalytic composition having a mole ratio of phosphorus to tungsten plus molybdenum of about 0.2:1 or greater.

In yet another embodiment, the process described above utilizes a molybdenum promoter and the aqueous slurry of titania is exposed to a soluble volatility inhibitor in order to deposit a volatility inhibitor on the titania. Suitable volatility inhibitors include soluble compounds of zirconium, tin, manganese, lanthanum, cobalt, niobium, zinc, bismuth, aluminum, nickel, chromium, iron, yttrium, gallium, germanium, indium, and mixtures thereof, and they act to improve the molybdenum retention of the catalyst during use.

In another embodiment, a method is provided for selective reduction of nitrogen oxides with ammonia, wherein the nitrogen oxides are present in a gas stream. Such methods involve contacting a gas or liquid with a vanadia-based catalytic composition as described above for a time sufficient to reduce the level of NOₓ compounds in the gas or liquid.

Thus, utilizing (1) the technology known in the art; (2) the above-referenced general description of the presently claimed and disclosed inventive concept(s); and (3) the detailed description of the invention that follows, the advantages and novelties of the presently claimed and disclosed inventive concept(s) would be readily apparent to one of ordinary skill in the art.

### DETAILED DESCRIPTION OF THE INVENTION

Before explaining at least one embodiment of the invention in detail, it is to be understood that the invention is not limited in its application to the details of construction, experiments, exemplary data, and/or the arrangement of the components set forth in the following description. The invention is capable of other embodiments or of being practiced or carried out in various ways. Also, it is to be understood that the terminology employed herein is for purpose of description and should not be regarded as limiting.

In both stationary and mobile DeNOₓ applications, it is desirable to replace the tungsten used in the selective catalytic reduction DeNOₓ catalyst with a less expensive and more available alternative such as molybdenum. Using molybdenum allows one to use a more active component which also has a molecular weight half that of tungsten. This reduces the amount of component used while maintaining desired conversions.

However, the use of molybdenum in a commercial selective catalytic reduction (SCR) catalyst is hampered, in part, by the relative volatility of the hydrous molybdenum oxide compared to tungsten counterparts. In the presence of water and high temperature, the molybdenum vaporizes, leading to molybdenum losses under commercial conditions. Thus, the use of molybdenum in SCR catalysts has been limited due to concern that volatility will result in eventual loss of catalyst activity and decline of catalyst selectivity due to loss of the promoter over time.

The molybdenum vaporization can be compensated for, somewhat, by using higher levels of molybdenum in the catalyst material. However, molybdenum-containing catalysts cause higher SO₂ oxidation rates compared to tungsten-containing systems in stationary DeNOₓ applications. SO₂ oxidation to SO₃ is undesirable because of the propensity of SO₃ to react with water and ammonia to form solid ammonium sulfate (NH₄)₂SO₄. Ammonium sulfate is a solid at typical exhaust temperatures of stationary sources. Therefore, it tends to clog process piping causing pressure drops in DeNOₓ equipment downstream of power generating equipment. Additional concerns stem from the fact that SO₃ is a stronger acid relative to SO₂, and its release to the atmosphere results in a higher rate of acid rain formation.

While initial research focused on the use of selected metal oxide volatility inhibitors to reduce the volatility of molybdenum, it was discovered that phosphate alone, added to the active catalyst phase and/or to the catalyst support, both reduces the rate of SO₂ oxidation and further stabilizes molybdenum from sublimation. Specifically, it was discovered that by adding phosphate at levels to achieve a mole ratio of phosphorus to molybdenum of about 0.2:1 or greater, the amount of molybdenum retained on the catalyst can be doubled. In addition, with phosphate additions at these levels, SO₂ oxidation rates are suppressed with no apparent change in NOₓ conversion rates at high temperatures, and NOₓ conversion rates at low temperatures are actually increased. Phosphate was also found to have the unexpected effect of helping to preserve the titania surface area at high calcination temperatures when using either molybdenum or tungsten as the primary promoter. It is also surprising to note that addition of phosphate suppresses titanium dioxide sintering under severe calcination conditions.

This is quite surprising because previously, phosphate was considered a “poison” in DeNOₓ catalysts using the standard tungsten promoter, both in terms of NOₓ conversion and in terms of SO₂ oxidation. For example, Walker et al. [1] teach that phosphorus in lubricating oil systems in diesel vehicles present poisoning problems to SCR catalysts. Chen et al. [2] teach that phosphorus (P) is a weak poison for the SCR catalyst and that a ratio of phosphorus to vanadium (P/V) of only 0.8 decreases DeNOₓ catalyst activity by 30%. Blanco et al. [3] teach that phosphorus will deactivate a vanadia-containing SCR catalyst and that the presence of phosphorus collapses the pore structure of the catalyst and causes accelerated sintering of the catalyst. Finally, Soria et al. [4] show that after a vanadium-containing catalyst is exposed to phosphorus, it requires excessively high calcination temperatures of 700° C. to regenerate activity.

Thus, the presently claimed and disclosed inventive concept(s) provides a vanadia-based catalytic composition for reduction of nitrogen oxides, utilizing a titania-based support material with vanadia deposited on the titania-based support material, a primary promoter comprising molybdenum oxide; and an amount of phosphate to achieve a mole ratio of phosphorus to molybdenum of about 0.2:1 or greater.

### Definitions

All terms used herein are intended to have their ordinary meaning unless otherwise provided.

The terms “catalyst support,” “support particles,” or “support material” are intended to have their standard meaning in the art and refer to particles comprising TiO₂ on the surface of which a catalytic metal or metal oxide component is to be deposited.

The terms “active metal catalyst” or “active component” refer to the catalytic component deposited on the surface of the support material that catalyzes the reduction of NOₓ compounds.

The terms “catalyst” and “catalytic composition” are intended to have their standard meaning in the art and refer to the combination of the supported catalyst components and the titania-based catalyst support particles.

Unless otherwise specified, all reference to percentage (%) herein refers to percent by weight. The terms “percent” and “loading” refer to the loading of a particular component on the total catalytic composition. For example, the loading of vanadium oxide on a catalyst is the ratio of the vanadium oxide weight to the total weight of the catalyst, including the titania-based support material, the vanadium oxide and any other supported metal oxides. Similarly, the loading in mole percent refers to the ratio of the number of moles of a particular component loaded to the number of moles in the total catalytic composition.

The term “phosphate” is used to refer to any compound containing phosphorus bound to oxygen.

Commercial vanadium-containing SCR catalysts typically use a titania-based support material. Titania is the preferred metal oxide support, although other metal oxides can be used as the support, examples of which include alumina, silica, alumina-silica, zirconia, magnesium oxide, hafnium oxide, lanthanum oxide, and the like. Such titania-based support materials and their methods of manufacture and use are known to those skilled in the art. The titania can include anatase titanium dioxide and/or rutile titanium dioxide.

Vanadia or vanadium pentoxide (V₂O₅), the active material, is deposited on or incorporated with a titanium dioxide support. The vanadia typically ranges between 0.5 and 5 weight percent depending upon the application. Tungsten oxide or molybdenum oxide is added as a promoter to achieve additional catalyst activity and improved catalyst selectivity. When the promoter is molybdenum oxide, the molybdenum oxide is typically added to the titania support material in an amount to achieve a mole ratio of molybdenum to vanadium of about 0.5:1 to about 20:1 in the final catalyst. Often, molybdenum oxide is added to the titania support material in an amount to achieve a mole ratio of molybdenum to vanadium of about 1:1 to about 10:1 in the final catalyst.

Previous vanadia catalyst compositions have used molybdenum oxide promoters, but have failed to combine sufficient quantities of phosphate to stabilize the molybdenum from sublimation. The vanadia-based catalytic composition of the presently claimed and disclosed inventive concept(s) utilizes phosphate added to the active catalyst phase and/or to the catalyst support to both reduce the rate of SO₂ oxidation and to stabilize molybdenum from sublimation. The phosphate is generally added at levels to achieve a mole ratio of phosphorus to molybdenum of about 0.2:1 or greater. In some embodiments, phosphate is added in an amount to achieve a mole ratio of phosphorus to molybdenum in the range of from about 0.2:1 to about 4:1.

While testing for molybdenum stabilization, it was discovered that when phosphate was added to a tungsten-promoted vanadia-based catalytic composition, at levels to achieve a mole ratio of phosphorus to tungsten of about 0.2:1 or greater, the resulting catalyst showed decreased SO₂ oxidation without significantly lower NOₓ conversion. In some embodiments, phosphate is added in an amount to achieve a mole ratio of phosphorus to tungsten in the range of from about 0.2:1 to about 4:1. Similarly, when both tungsten and molybdenum promoters are present, phosphate is added at levels to achieve a mole ratio of phosphorus to tungsten plus molybdenum of about 0.2:1 or greater, and in some embodiments, at levels to achieve a mole ratio of phosphorus to tungsten plus molybdenum in the range of from about 0.2:1 to about 4:1.

Suitable phosphate-containing compounds include, but are not limited to, organic phosphates, organic phosphonates, phosphine oxides, H₄P₂O₇, H₃PO₄, polyphosphoric acid, (NH₄)H₂PO₄, (NH₄)₂HPO₄, and (NH₄)₃PO₄. The phosphate can be present within the support material, or it can be present on the surface of the support material.

In certain embodiments, a volatility inhibitor is also added to the vanadia-based catalytic composition. The volatility inhibitor can be tin oxide, manganese oxide, lanthanum oxide, zirconium oxide, bismuth oxide, zinc oxide, niobium oxide, cobalt oxide, aluminum oxide, nickel oxide, chromium oxide, iron oxide, yttrium oxide, gallium oxide, germanium oxide, indium oxide, or combinations thereof. The volatility inhibitor can be added in sufficient quantities to achieve a mole ratio of volatility inhibitor to molybdenum in the range of from about 0.05:1 to about 5:1. When both phosphate and the volatility inhibitor are utilized with a molybdenum oxide promoter, the phosphate at a mole ratio of phosphorus to molybdenum of about 0.2:1 or greater, molybdenum retention is greatly improved and SO₂ oxidation is significantly reduced. The combination of phosphate and selected metal oxide volatility inhibitors synergistically provides the best combination of molybdenum stability and low SO₂ oxidation rates.

In one embodiment, the volatility inhibitor is tin oxide present in a quantity to achieve a mole ratio of tin to molybdenum in the range of from about 0.1:1 to about 2:1. In another embodiment, the volatility inhibitor is zirconium oxide present in a quantity to achieve a mole ratio of zirconium to molybdenum in the range of from about 0.1:1 to about 1.5:1.

Others have used promoters of molybdenum, manganese and tin, but have not discovered or recognized the synergistic effect of phosphate in their formulation. For example, U.S. Pat. No. 4,966,882 discloses a catalyst composition having at least one of V, Cu, Fe, and Mn with at least one of Mo, W, and Sn oxide where the second group is added via vapor deposition to give a catalyst with improved resistance to poisons. The vapor deposition step actually requires a high degree of Mo volatility, rather than decreased Mo volatility, in order for the catalyst preparation to be effective. Also, U.S. Pat. No. 4,929,586 discloses a formed titania support with specific pore volume including the components of Mo, Sn, and Mn. Again, however, there was no attempt to combine P in the formulations to improve Mo stability and catalyst performance.

The catalyst composition disclosed in U.S. Pat. No. 5,198,403 teaches the formation of a catalyst by combining: A) TiO₂, B1) at least one from W, Si, B, Al, P, Zr, Ba, Y, La and Ce, and B2) at least one from V, Nb, Mo, Fe and Cu. The catalyst is formed by pre-kneading A with B1, and then kneading with B2 to form a homogeneous mass, extruding, drying and calcining. Again, the inventors fail to recognize the stabilizing effect of P on Mo volatility or the impact it has on reducing SO₂ oxidation and surface area sintering, probably due to the very low concentrations of phosphorus used. There was also no recognition of the improvement due to use of a volatility inhibitor such as tin or manganese.

In another embodiment, a process is provided for making the above-described vanadia-based catalytic compositions for reduction of nitrogen oxides. The process includes the following steps. An aqueous slurry of titania, sometimes referred to as a hydrolyzed titania gel, is provided and is exposed to a soluble promoter compound, wherein the promoter comprises tungsten and/or molybdenum. The pH is adjusted to a value allowing deposition of the promoter to yield a hydrolyzed promoter-titania mixture. Water is removed from the hydrolyzed promoter-titania mixture, optionally by filtration and drying, to produce promoter-titania mixture solids. The promoter-titania mixture solids are then calcined to produce a support material, which is added to an aqueous solution of vanadium oxide to produce a product slurry. A phosphate compound is added in sufficient quantity to achieve a mole ratio of phosphorus to tungsten plus molybdenum of about 0.2:1 or greater in the product slurry. The phosphate compound can be added during support preparation, such as to the hydrolyzed promoter-titania mixture prior to water removal. Optionally, the phosphate can be added during deposition of the active phase, such as directly after addition of the aqueous solution of vanadium oxide to the support material. In either case, water is removed from the product slurry to produce product solids that are calcined to form a vanadia-based catalytic composition for reduction of nitrogen oxides, the vanadia-based catalytic composition having a mole ratio of phosphorus to tungsten plus molybdenum of about 0.2:1 or greater.

Methods for preparing the hydrolyzed titania gel are well known to those skilled in the art, as are methods for adding the tungsten promoter. The molybdenum promoter is prepared as an aqueous salt solution such as ammonium molybdate. Other suitable molybdenum-containing salts include, but are not limited to, molybdenum tetrabromide, molybdenum hydroxide, molybdic acid, molybdenum oxychloride, molybdenum sulfide. When molybdenum is used as the promoter, the molybdenum salt solution is mixed with the hydrolyzed titania sol and the pH is adjusted to fall within a range of from about 2 to about 10.

If a volatility inhibitor is used, an aqueous solution of a salt containing the volatility inhibitor is prepared and added to the hydrolyzed titania sol with the molybdenum salt solution. Any soluble salt of zirconium, tin manganese, lanthanum, cobalt, niobium, zinc, aluminum, nickel, chromium, iron, yttrium, gallium, germanium, indium, and/or bismuth can be added to reduce molybdenum volatility during the resulting catalyst use. For example, suitable tin salts include, but are not limited to, tin sulfate, tin acetate, tin chloride, tin nitrate, tin bromide, tin tartrate. Suitable zirconium salts include, but are not limited to, zirconium sulfate, zirconium nitrate and zirconium chloride. Suitable manganese salts include, but are not limited to, manganese sulfate, manganese nitrate, manganese chloride, manganese lactate, manganese metaphosphate, manganese dithionate. The mixture is stirred and the pH is adjusted to fall within a range of from about 2 to about 10.

Optionally, at this point the pH is further adjusted to about 7 and a phosphate compound is added to the slurry. Suitable phosphate compounds include, but are not limited to, organic phosphates, organic phosphonates, phosphine oxides, H₄P₂O₇, H₃PO₄, polyphosphoric acid, (NH₄)H₂PO₄, (NH₄)₂HPO₄, and (NH₄)₃PO₄. The slurry is de-watered by means known in the art such as centrifuging, filtration, and the like. The mixture is then dried and calcined, again using procedures and equipment well known to those skilled in the art. Calcination temperatures are typically around 500° C. but can range from 250° C. to about 650° C.

The active vanadia phase is deposited on the prepared support and slurrying this in 20 ml water. To this, vanadium pentoxide V₂O₅ and a solvent such as monoethanolamine (C₂ONH₅) are added and the temperature of the mixture is raised to a range of about 30 to about 90° C. Other suitable solvents include amines, alcohols, carboxylic acids, ketones, mono, di, and tri-alcohol amines. Water is then evaporated from the mixture, and the solid is collected, dried and calcined at 600° C. Calcination temperatures are typically around 600° C. but can range from 300° C. to about 700° C.

Optionally, phosphate can be added during the deposition of the active phase rather than during the support preparation. This is accomplished by increasing the pH to about 9 and adding a phosphate compound such as H₄P₂O₇ after vanadia addition. Again, solvent is removed via evaporation. The solids are dried and calcined at around 600° C., as described above.

The combined addition of P with Mo stabilizers zirconium oxide, tin oxide and manganese oxide, during the preparation of the catalyst, was found to synergistically reduce Mo volatility from the catalyst during use. The combined addition of P with other Mo stabilizers was found to reduce the amount of SO₂ oxidation, but without reducing NOₓ conversion.

Further improvement in catalyst performance can be achieved by addition of various other transition or main group metals. The metal can be added as a soluble salt during either the support preparation steps or during deposition of the vanadium oxide active phase. Nonlimiting examples of suitable transition or main group metals include lanthanum, cobalt, zinc, copper, niobium, silver, bismuth, aluminum, nickel, chromium, iron, yttrium, gallium, germanium, indium, and combinations thereof.

In order to further illustrate the presently claimed and disclosed inventive concept(s), the following examples are given. However, it is to be understood that the examples are for illustrative purposes only and are not to be construed as limiting the scope of the invention.

### Example 1

The catalysts were prepared in two steps. The first step prepared the support and the second applied the active phase. The first step in support preparation was to make two metal salt solutions. One solution was 1.47 g tin sulfate (SnSO₄) in 100 mL water. The other solution contained molybdenum and was made by dissolving 4.74 g ammonium molybdate [(NH₄)₆Mo₇O₂₄.4H₂O] into 100 ml water. The solutions were added to an aqueous slurry of titania gel (440 g of 27.7% titania hydrolysate produced at Cristal Global's titania plant located in Thann, France). Alternatively, a calcined titania powder such as Cristal Global's DT51™ can be used as the titanium dioxide starting material. In the case of the latter 120 g of powder is slurried in 320 g of de-ionized water. In both cases the pH was then adjusted to 5 using ammonium hydroxide. The slurry was mixed for 10 minutes. At this point, the pH was further adjusted to 7 and a phosphate compound was added (1.57 g H₄P₂O₇) to the slurry. Mixing continued for another 15 minutes and the mixture was then filtered, dried at 100° C. for 6 hrs, and calcined in air at 500° C. for 6 hrs.

The active phase was deposited by taking 10 g of the prepared support and slurrying this in 20 ml water. To this, 0.133 g of vanadium pentoxide (V₂O₅) and 0.267 g of monoethanolamine (C₂ONH₅) were added and the temperature of the mixture was raised to 60° C. The mixture was allowed to stir for 10 minutes. Water was then evaporated from the mixture, and the solid was collected, dried at 100° C. for 6 hrs, and calcined at 600° C. for 6 hrs in air. Unless otherwise indicated, all catalysts were prepared with nominal vanadia loadings of 1.3 wt % (0.57 mol %).

As an alternative to the above preparation method, phosphate can be added during the deposition of the active phase rather than during the support preparation. This would be done by increasing the pH to 9 and adding the phosphate compound (for example, 0.109 g H₄P₂O₇) after vanadia addition. Again, solvent water is removed via evaporation. The solid is dried at 100° C. and calcined at 600° C. as described above.

DeNOₓ conversion was determined using a catalyst in the powder form without further shaping. A ⅜″ quartz reactor holds 0.1 g catalyst supported on glass wool. The feed gas composition was 500 ppm of NO, 500 ppm of NH₃, 5% O₂, 5% H₂O, and balance N₂. NO conversion was measured at 250° C., 350° C., and 450° C. at atmospheric pressure. The reactor effluent was analyzed with an infrared detector to determine NO conversion and NH₃ selectivity.

SO₂ oxidation was determined with a catalyst in powder form without further shaping. A ⅜″ quartz reactor held 0.2 g catalyst supported on glass wool. The feed gas composition was 500 ppm SO₂, 20% O₂, and the balance N₂. The space velocity was 29.5 L/(g cat)(hr) calculated at ambient conditions. Conversion data was recorded at 500° C., 525° C., and 550° C., and reported for both 525° C. and 550° C. readings or for the 550° C. reading alone.

Mo volatility was determined by first hydrothermally treating the calcined catalyst sample in a muffle furnace at 700° C. for 16 hrs while exposing it to a flow of 10% water vapor in air. The final Mo loading was determined after digesting the sample and using ICP-OES (inductively coupled plasma optical emission spectroscopy) to measure concentration.

The results from our studies are contained in Table I below.

TABLE 1
Effect of Phosphate and Volatility Inhibitors on Catalyst Performance

| | | | | | | | Mo | | | | | | |
|---|---|---|---|---|---|---|---|---|---|---|---|---|---|
| | | | | | | | Loading | | | | | | |
| | | | | | | | after | | | | | | |
| | | Primary Promoter | | Volatility Inhibitor | | PO₄ | 700° C. | Mo | | | | SO₂ Oxidation | |
| | | | Loading | | Loading | Loading | Treatment | Retention | NOₓ Conversion (%) | | | (%) | |
| Ex. No. | Support | Element | (mol %) | Element | (mol %) | (mol %) | (mol %) | (%) | 250° C. | 350° C. | 450° C. | 525° C. | 550° C. |
| 1-1 | DTW5 | W | 1.74 | | | | NA | NA | 8.4 | 43.9 | 63.0 | 12.20 | 17.54 |
| | DTW5 | W | 1.74 | | | 1.15 | NA | NA | 14.2 | 40.7 | 52.3 | 8.34 | 9.72 |
| 1-2 | G1 | Mo | 1.67 | | | | 0.52 | 31% | 10.0 | 52.3 | 66.7 | 13.37 | 21.28 |
| | DT51 | Mo | 1.67 | | | | 0.70 | 42% | 12.8 | 63.2 | 70.9 | 12.04 | 18.04 |
| 1-3 | G1 | Mo | 1.67 | | | 1.15 | 1.22 | 73% | 17.9 | 58.1 | 63.8 | 11.68 | 14.82 |
| | DT51 | Mo | 1.67 | | | 2.53 | 1.20 | 72% | 21.0 | 61.5 | 61.2 | 7.08 | 10.13 |
| 1-4 | G1 | Mo | 1.67 | Sn | 0.43 | | 0.79 | 48% | 9.5 | 54.1 | 65.2 | 13.07 | 18.87 |
| | G1 | Mo | 1.67 | Sn | 0.22 | | 0.62 | 37% | 9.3 | 42.0 | 58.0 | 13.44 | 18.73 |
| | G1 | Mo | 1.67 | Sn | 0.22 | 2.53 | 1.43 | 86% | 16.9 | 35.9 | 41.6 | 8.24 | 11.37 |
| 1-5 | G1 | Mo | 1.67 | Mn | 0.42 | | 0.76 | 46% | 9.6 | 59.9 | 72.3 | | |
| | G1 | Mo | 1.67 | Mn | 0.22 | | 0.45 | 27% | 9.2 | 53.9 | 64.2 | | |
| | G1 | Mo | 1.67 | Mn | 0.22 | 2.53 | 1.00 | 60% | | | | | |
| 1-6 | G1 | Mo | 0.93 | Mn | 0.42 | 1.15 | 10.93 | 101% | | 37.8 | | | |
| | G1 | Mo | 0.93 | Sn | 0.43 | 1.15 | 0.89 | 96% | | 37.7 | | 8.83 | 15.80 |

Test 1-1 is a conventional W-containing catalyst available commercially from Cristal Global's titania plant located in Thann, France, under the trademark DTW5™. Test 1-1 results show that P can reduce SO₂ oxidation in a W-containing catalyst. It should also be noted that this reduction in SO₂ oxidation does not come at the expense of a significant loss in NOₓ conversion at 350° C.

Test 1-2 shows results from catalysts made using Mo at comparable loadings using commercial supports G1™ or DT51™ as starting materials, the supports available commercially from Cristal Global's titania plant located in Thann, France. It can be seen from the results that NOₓ conversions are measurably higher and SO₂ oxidation rates are comparable for the Mo promoted catalyst relative to W at the same molar loadings. One can see the disadvantage of using a Mo catalyst without the presently disclosed inventive concepts is that about two thirds of the promoter is lost during hydrothermal aging.

The amount of Mo retained is doubled by adding phosphate to the formulation according to the recipe (Test 1-3). In addition, SO₂ oxidation rates are suppressed, NOₓ conversion is increased at 250° C., and there is no apparent change in NOₓ conversion at higher temperatures.

Mo volatility is also suppressed by the addition of either Sn or Mn oxides (Tests 1-4 and 1-5, respectively). The two examples show that Mo retention is comparable for the highest loadings of the secondary metal oxide. However, at the lower loadings investigated, Mn does not appear to suppress Mo volatility, whereas Sn does. Addition of phosphate improves Mo stability further in both examples. However, again, in the case of Mn, the improvement is no better than that for phosphate alone, while for Sn, there appears to be the combined effect of the two components leading to higher Mo retention than seen for either Sn or phosphate alone. It is also seen in Test 1-4 that phosphate brings the added advantage of suppressing SO₂ oxidation as well.

Test 1-6 shows that at certain compositions Mo volatility under these conditions can be virtually eliminated. In this case the Mo loading was nominally 1 wt % (measured as 0.93 mol %).

### Example 2

Phosphate also has the unexpected effect of helping to preserve titania surface area under increasing calcination severity, as shown in Table 2 below. Surface area measurements for Test 2-1 show that the addition of phosphate on a tungsten catalyst with 0.55 mol % V₂O₅ increases surface area by almost 15 m²/g after a 600° C. calcination. Test 2-2a showed the expected result of decreasing surface area as the severity of calcination increases from 600° C. to 700° C. in 50° C. increments. Test 2-2b shows that phosphate helps limit these losses. Surface area and pore volume measurements for Tests 2-3 through 2-6 show that this same behavior is observed when Mo replaces W as the primary promoter. The differences between the examples are the increasing Mo and V₂O₅ loadings.

TABLE 2
Effect of Phosphate on Catalyst BET Surface Area and Pore Volume

| | | | Primary Promoter | | | | | |
|---|---|---|---|---|---|---|---|---|
| | | V₂O₅ Loading | | Loading | PO₄ Loading | Calcination | BET | PV |
| Example | Stat | (mol %) | Element | (mol %) | (mol %) | Temp (C.) | (m²/g) | cm³/g |
| 2-1 | 392 | 0.40 | W | 1.74 | 0.00 | 600 | 59.14 | 0.25 |
| | 396 | 0.40 | W | 1.74 | 0.37 | 600 | 73.93 | 0.26 |
| 2-2a | 394 | 0.57 | W | 1.74 | 0.00 | 600 | 56.84 | 0.25 |
| | 394 | 0.57 | W | 1.74 | 0.00 | 650 | 49.67 | 0.23 |
| | 394 | 0.57 | W | 1.74 | 0.00 | 700 | 37.63 | 0.19 |
| 2-2b | 395 | 0.57 | W | 1.74 | 0.52 | 600 | 74.92 | 0.26 |
| | 395 | 0.57 | W | 1.74 | 0.52 | 650 | 71.96 | 0.24 |
| | 395 | 0.57 | W | 1.74 | 0.52 | 700 | 45.62 | 0.21 |
| 2-3a | 321 | 0.40 | Mo | 0.42 | 0.00 | 600 | 59.51 | 0.25 |
| 2-3b | 323 | 0.40 | Mo | 0.42 | 0.37 | 600 | 69.06 | 0.26 |
| 2-4a | 320 | 0.40 | Mo | 0.83 | 0.00 | 600 | 57.39 | 0.25 |
| | 346 | 0.40 | Mo | 0.83 | 0.00 | 600 | 58.68 | 0.26 |
| | 346 | 0.40 | Mo | 0.83 | 0.00 | 650 | 43.45 | 0.20 |
| | 346 | 0.40 | Mo | 0.83 | 0.00 | 700 | 35.50 | 0.18 |
| 2-4b | 335 | 0.40 | Mo | 0.83 | 0.37 | 600 | 68.08 | 0.25 |
| | 335 | 0.40 | Mo | 0.83 | 0.37 | 650 | 56.19 | 0.24 |
| | 335 | 0.40 | Mo | 0.83 | 0.37 | 700 | 43.76 | 0.20 |
| 2-5 | 347 | 0.57 | Mo | 0.83 | 0.00 | 600 | 60.78 | 0.26 |
| | 337 | 0.57 | Mo | 0.83 | 0.52 | 600 | 79.18 | 0.25 |
| 2-6a | 404 | 0.57 | Mo | 1.25 | 0.00 | 600 | 55.10 | 0.25 |
| | 404 | 0.57 | Mo | 1.25 | 0.00 | 650 | 40.97 | 0.20 |
| 2-6b | 406 | 0.57 | Mo | 1.25 | 0.52 | 600 | 68.29 | 0.26 |
| | 406 | 0.57 | Mo | 1.25 | 0.52 | 650 | 55.63 | 0.25 |

### Example 3

Additional tests were run varying the loading of molybdenum, phosphorus and tin. The test procedures followed those described in Example 1 and the results are shown in Table 3 below. We found that there needs to be a balance in loadings to optimize the system. For example, at high Sn/Mo ratios more Sn will deactivate the catalyst, whereas at lower ratios more Sn gives an increase in activity. We found the best balance between NOₓ conversion, Mo retention and low SO₂ oxidation at intermediate loadings of all three components.

TABLE 3
Effect of varying Mo, P and Sn

| | | | | | | NOₓ Conversion (%) | | | |
|---|---|---|---|---|---|---|---|---|---|
| | | | | Mo after | | | | | SO₂ |
| Test | Mo | | Sn | 700° C. HT | Mo | | | | Oxidation at |
| No. | (mol %) | P(mol %) | (mol %) | (mol %) | Retained | 250° C. | 350° C. | 450° C. | 550° C. (%) |
| 3a | 1.67 | 2.58 | 0.86 | 1.42 | 85% | 13.6 | 37.6 | 42.8 | 10.44 |
| | 1.67 | 1.29 | 0.86 | 1.36 | 82% | 14.6 | 47.6 | 52.5 | 13.85 |
| | 1.67 | 2.58 | 0.43 | 1.23 | 74% | 11.8 | 42.1 | 50.0 | 13.43 |
| | 1.67 | 1.29 | 0.43 | 0.74 | 45% | 10.5 | 53.6 | 67.4 | 20.61 |
| 3b | 3.33 | 2.58 | 0.43 | 1.68 | 50% | 18.3 | 53.4 | 55.4 | 14.14 |
| | 3.33 | 2.58 | 0.86 | 1.56 | 47% | 25.5 | 56.0 | 58.1 | 13.57 |
| | 3.33 | 1.29 | 0.86 | 1.26 | 38% | 19.4 | 66.9 | 71.1 | 14.23 |
| | 3.33 | 1.29 | 0.43 | 0.93 | 28% | 20.9 | 54.6 | 60.5 | 16.33 |
| 3c | 2.50 | 1.94 | 0.65 | 1.83 | 73% | 18.9 | 52.4 | 60.4 | 10.65 |
| | 2.50 | 1.94 | 0.65 | 2.00 | 80% | 17.4 | 53.9 | 56.4 | 11.45 |

As can be seen from Test Nos. 3a and 3b in Table 3, Sn and P both increase Mo retention and Sn and P also both decrease SO₂ oxidation (Test 3a). Sn appears to decrease NOₓ conversion at low Mo loadings (Test 3a), and also appears to increase NOₓ conversion at high Mo loadings (Test 3b). Tests 3a and 3b show that P decreases NOₓ conversion at both high and low loadings. All tests show that Mo increases NOₓ conversion and SO₂ oxidation. Thus, it is important to balance the loadings of P, Sn with Mo to optimize NOₓ conversion, Mo retention, and minimize SO₂ oxidation as in Test No. 3c.

### Example 4

Additional tests were run using the procedures of Example 1 to determine the effect of the order of Mo, P and Sn addition on NOₓ conversion. As can be seen from the results shown in Table 4, the order of addition is important, contradicting the teaching in the prior art.

TABLE 4
Effect of the Order of Addition

| Test | | | | Mo | P | Sn | NOₓ Conversion (%) | | |
|---|---|---|---|---|---|---|---|---|---|
| No. | Order of Addition | | | mol % | mol % | mol % | 250° C. | 350° C. | 450° C. |
| 4a | 1) 3% Mo | 2) 0.96% Sn | 3) 0.75% P | 2.50 | 1.94 | 0.65 | 13.9 | 58.8 | 64.9 |
| 4b | 1) 3% Mo | 2) 0.75% P | 3) 0.96% Sn | 2.50 | 1.94 | 0.65 | 16.0 | 55.7 | 55.0 |
| 4c | 1) 0.96% Sn | 2) 0.75% P | 3) 3% Mo | 2.50 | 1.94 | 0.65 | 12.6 | 54.2 | 61.3 |
| 4d | 1) 0.96% Sn | 2) 3% Mo | 3) 0.75% P | 2.50 | 1.94 | 0.65 | 12.8 | 51.2 | 57.9 |
| 4e | 1) 0.75% P | 2) 0.96% Sn | 3) 3% Mo | 2.50 | 1.94 | 0.65 | 13.3 | 47.8 | 49.1 |
| 4f | 1) 0.75% P | 2) 3% Mo | 3) 0.96% Sn | 2.50 | 1.94 | 0.65 | 19.1 | 47.2 | 49.1 |

Adding Mo first gives the highest NOₓ conversion. Adding Sn first may result in slightly lower NOₓ conversion; however, the results are extremely close and may be within natural experimental variability. Adding P first clearly results in the lowest NOₓ conversion. It appears to be less important as to which element is added 2^{nd} and 3^{rd}.

The importance of adding Mo prior to P was an unexpected result and contradicts the teachings in U.S. Pat. No. 5,198,403, to Brand et al. which states that P should be added prior to Mo. Brand et al. also do not show the potential for P to reduce NOₓ conversion as demonstrated herein. This may be due to the very low P loadings in the examples for which Brand et al. reported reactor tests and which may not have allowed them to see these effects. This argument is further supported hereinafter by Example 6.

### Example 5

The effect of other transition metals on NOₓ conversion and Mo retention was examined. Specifically, lanthanum, cobalt, zinc, zirconium, bismuth, silver, niobium and copper were tested using the general catalyst preparation procedures described in previous examples. Lanthanum was added as LaCl₃.7H₂O; cobalt was added as Co(NO₃)₂.6H₂O; zinc was added as ZnSO₄.7H₂O; zirconium was added as Zr(SO₄)₂.4H₂O; bismuth was added as bismuth citrate; silver was added as AgNO₃; niobium was added as Nb(HC₂O₄)₅.6H₂O; and copper was added as CuSO₄.5H₂O. Each salt was first dissolved in 50 ml water and added after the Mo solution and prior to adding phosphorus (when added). Example 5a contains the results for four metals without any additional phosphorus. Example 5b includes the effects of the transition metal volatility inhibitors and phosphorus.

The transition metals are listed in Table 5 below in order of decreasing effectiveness as Mo volatility inhibitors. The results show that the transition metal affects the amount of Mo retained as well as NOₓ conversion. Of the eight metals tested, the Mo stabilization improves according to: Cu<Nb<Ag<Bi<Zr<Zn<Co<La, but the NOₓ conversion improves according to: Ag<La<Bi<Zr<Zn<Nb<Co<Cu. The different orders show that effects on Mo retention cannot be inferred from relative NOₓ conversion, which is another surprising result.

The results in Table 5 show clearly that Mo retention does not parallel improvements in catalyst performance. NOₓ conversion is best for catalysts modified with Cu and Co and poorest when Ag and La are the promoters; whereas, Mo retention is best for La and Zr and poorest for Cu and Ag. Thus, one cannot assume a material that improves NOₓ conversion necessarily also improves Mo retention, further distinguishing the presently claimed and disclosed inventive concept(s) from prior art that focus on catalyst performance in terms of NOₓx conversion alone.

TABLE 5
Effect of Transition Metals on Mo Retention and NOₓ Conversion

| | | | | Promoter | | | |
|---|---|---|---|---|---|---|---|
| | Mo | P | | Loading | Mo after 700 | Mo | NOₓ Conv. at |
| Example | (mol %) | (mol %) | Promoter | (mol %) | HT (mol %) | Retained | 350° C. (%) |
| 5a | 1.67 | 0 | La | 0.40 | 1.63 | 98% | 49.4 |
| | 1.67 | 0 | Zr | 0.44 | 1.54 | 93% | 54.9 |
| | 1.67 | 0 | Ag | 0.44 | 0.74 | 45% | 53.5 |
| | 1.67 | 0 | Cu | 0.43 | 0.66 | 40% | 62.2 |
| 5b | 0.97 | 1.24 | La | 0.50 | 0.91 | 94% | 33.2 |
| | 1.02 | 1.24 | Co | 0.53 | 0.92 | 90% | 40.4 |
| | 1.02 | 1.24 | Zn | 0.53 | 0.92 | 90% | 35.1 |
| | 1.02 | 1.24 | Zr | 0.52 | 0.91 | 89% | 34.3 |
| | 1.07 | 1.24 | Bi | 0.55 | 0.93 | 87% | 34.0 |
| | 0.95 | 1.24 | Ag | 0.49 | 0.82 | 86% | 31.4 |
| | 0.99 | 1.24 | Nb | 0.51 | 0.84 | 85% | 37.8 |
| | 1.04 | 1.24 | Cu | 0.54 | 0.74 | 71% | 43.0 |

### Example 6

The purpose of this example is to show that combined phosphomolybdates show little effectiveness due to the fact that P loading relative to Mo is low. In Example 6a and 6c, the catalyst is prepared as described in the previous examples. However, in example 6b, ammonium phosphomolybdate is used as the source for both Mo and P.

The P to Mo ratio of 1:12 in the compound identified below is comparable to compounds used by Brand et al. in U.S. Pat. No. 5,198,403, and thus confirms our statement as to why they did not see an effect from their phosphorus loadings. Additionally, it confirms that a P:Mo molar ratio of 0.2 to 1 is a lower limit for which addition of phosphorus produces desirable results.

In each of the example tests 6a-6c reported in Table 6, Mo was the primary promoter and was loaded at a level of 1.25 mol %. Note that the combined phosphorus-molybdenum compound of Example 6b, (NH₄)₃PO₄.12MoO₃.3H₂O, does not significantly affect SO₂ oxidation nor Mo retention relative to tests where phosphorus is not added to the system (Example 6a). However, when P and Mo are added as two separate compounds, (NH₄)₆Mo7O₂₄.4H₂O and H₄P₂O₇ as in Example 6c, one has an extra degree of freedom to vary the loadings independently to achieve desired effects.

TABLE 6
Results with Low P/Mo Ratios

| | | | |
|---|---|---|---|
| PO4 | Mo After | Mo | SO₂ |

| Ex. | | P | Loading | 700° C. HT | Ret. | NOₓ Conversion (%) | | | Oxidation | |
|---|---|---|---|---|---|---|---|---|---|---|
| No. | Mo Source | Source | (mol %) | (mol %) | (%) | 250° C. | 350° C. | 450° C. | 525° C. | 550° C. |
| 6a | (NH₄)₆Mo₇O₂₄•4H₂O | NA | 0 | 0.51 | 41% | 10.1 | 46.2 | 60.6 | 14.85 | 24.45 |
| 6b | (NH₄)₃PO₄•12MoO₃•3H₂O | | 0.10 | 0.57 | 46% | 3.4 | 43.2 | 70.1 | 13.65 | 19.42 |
| 6c | (NH₄)₆Mo₇O₂₄•4H₂O | H₄P₂O₇ | 1.12 | 1.22 | 97% | 11.6 | 45.3 | 55.0 | 9.58 | 12.58 |

### Example 7

This following example demonstrates the effect of Zr on Mo retention. This is industrially important because Zr is less expensive and more commonly (and more easily) used in catalyst systems compared to Sn. In the following tests, Zr loadings were increased from 0 mol % to 0.25 mol %. It is clear from this example that the 0.08 mol % Zr loading (Test 7b) improves Mo retention, but not to the 100% target we want. However, loadings of 0.16 and 0.25 mol %, Tests 7c and 7d, respectively, do increase Mo retention to nearly 100%. It is also apparent from comparing NOₓ conversion results of Test 7a to those containing Zr, that this retention is gained at a small cost to NOₓ conversion. Additionally, the presence of Zr does not affect SO₂ oxidation rates.

Thus, Zr shows better performance compared to Sn and Mn in terms of Mo retention. Also, the ratio of volatility inhibitor to Mo loading can be reduced to as low as about 0.05 to 1 with favorable results.

TABLE 7
Results Using a Zr Volatility Inhibitor

| | | | Mo Loading | | | | | | |
|---|---|---|---|---|---|---|---|---|---|
| | | | after 700° C. | Mo | | | | | |
| Test | Mo | Zr | HT Treatment | Ret | NOₓ Conv. (%) | | | SO₂ Ox′n (%) | |
| No. | (mol %) | (mol %) | (mol %) | (%) | 250° C. | 350° C. | 450° C. | 525° C. | 550° C. |
| 7a | 1.25 | 0 | 0.51 | 41 | 10.1 | 46.2 | 60.6 | 14.85 | 24.45 |
| 7b | 1.25 | 0.08 | 1.01 | 81 | 6.6 | 36.5 | 53.8 | 14.96 | 21.40 |
| 7c | 1.25 | 0.16 | 1.21 | 97 | 7.7 | 37.2 | 54.2 | 15.20 | 20.89 |
| 7d | 1.25 | 0.25 | 1.20 | 96 | 6.0 | 38.9 | 59.4 | 15.13 | 22.27 |

From the above examples and descriptions, it is clear that the present inventive process(es), methodology(ies), apparatus(es) and composition(s) are well adapted to carry out the objects and to attain the advantages mentioned herein, as well as those inherent in the presently provided disclosure. While presently preferred embodiments of the invention have been described for purposes of this disclosure, it will be understood that numerous changes may be made which will readily suggest themselves to those skilled in the art and which are accomplished within the spirit of the presently claimed and disclosed inventive concept(s) described herein.

### CITED REFERENCES

1. A. P. Walker, P. G. Blakeman, I. Ilkenhans, B. Mangusson, A. C. McDonald, P. Kleijwegt, F. Stunnerberg, & M. Sanchez, “The Development and In Field Demonstration of Highly Durable SCR Catalysts Systems”, SAE 2004-01-1289, Detroit, 2004, teach that P in lubricating oil systems in diesel vehicles present poisoning problem to SCR catalysts.
2. J. P. Chen, M. A. Buzanowski, R. T. Yang, J. E. Cichanowicz, “Deactivation of the Vanadium Catalysts in the Selective Catalytic Reduction Process”, J. Air Waste Manage. Assoc., Vol. 40, p. 1403, (1990), teach that P is a weak poison for the SCR catalyst with a ratio of added P/V ratio of only 0.8 decreases DeNOₓ catalyst activity by 30%.
3. J. Blanco, P. Avila, C. Barthelemey, A. Bahamonde, J. A. Ordriozola, J. F. Gacia de la Banda, H. Heinemann, “Influence of P in V-Containing Catalysts for NOₓ Removal”, teach that P will deactivate a V-containing SCR catalyst they also teach that the presence of P collapses the pore structure of the catalyst and causes accelerated sintering of the catalyst.
4. J. Soria, J. C. Conesa, M. Lopez-Granados, J. L. G Fierro, J. F. Garcia de la Banda, H. Heinemann, “Effect of Calcination of V—O—Ti—P Catalysts”, p. 2717 in “New Frontiers in Catalysis”, L. Guzci, F. Solymosi, P. Tetenyi, eds., Elsevier, 1993, show that after V-containing catalyst is exposed to P it requires excessively high calcination temperatures of 700° C. to regenerate activity.

1. (canceled)

2. (canceled)

3. (canceled)

4. (canceled)

5. (canceled)

6. (canceled)

7. A titania-based catalyst support material comprising titania, a primary promoter comprising molybdenum oxide, and an amount of phosphate to achieve a mole ratio of phosphorus to molybdenum of about 0.2:1 or greater, further comprising a volatility inhibitor selected from the group consisting of zirconium oxide, tin oxide, and combinations thereof, wherein the volatility inhibitor is deposited from an aqueous solution containing a water soluble zirconium and/or tin salt.

8. The titania-based catalyst support material of claim 7, wherein the volatility inhibitor is present in an amount to achieve a mole ratio of volatility inhibitor to molybdenum in the range of from about 0.05:1 to about 5:1.

9. (canceled)

10. The titania-based catalyst support material of claim 8, further comprising a transition or main group metal selected from the group consisting of lanthanum, cobalt, zinc, copper, niobium, silver, bismuth, aluminum, nickel, chromium, iron, yttrium, gallium, germanium, indium, and combinations thereof.

11. The titania-based catalyst support material of claim 10, wherein the transition or main group metal is selected from the group consisting of lanthanum, cobalt, zinc and combinations thereof.

12. The titania-based catalyst support material of claim 8, wherein the volatility inhibitor is zirconium oxide.

13. The titania-based catalyst support material of claim 8, wherein the volatility inhibitor and the phosphate are present at levels balanced to achieve an optimum combination of NOₓ conversion and SO₂ oxidation in applications wherein the support material is combined with vanadium to produce a vanadia-based catalytic composition for reduction of nitrogen oxides.

14. The titania-based catalyst support material of claim 13, wherein the phosphate is present in an amount to achieve a mole ratio of phosphorus to molybdenum in the range of from about 0.2:1 to about 4:1; and
wherein the molybdenum is present in an amount to achieve a mole ratio of molybdenum to vanadium in the range of from about 0.5:1 to about 20:1.

15. The titania-based catalyst support material of claim 14, wherein the titania-based catalyst support material further comprises a transition or main group metal selected from the group consisting of lanthanum, cobalt, zinc and combinations thereof.

16. A vanadia-based catalytic composition for reduction of nitrogen oxides, the catalytic composition comprising a titania-based support material, vanadia deposited on the titania-based support material, a primary promoter comprising molybdenum oxide, and an amount of phosphate to achieve a mole ratio of phosphorus to molybdenum of about 0.2:1 or greater.

17. The vanadia-based catalytic composition of claim 16, wherein the catalytic composition is essentially free from tungsten.

18. The vanadia-based catalytic composition of claim 16, wherein the phosphate is present in an amount to achieve a mole ratio of phosphorus to molybdenum in the range of from about 0.2:1 to about 4:1.

19. The vanadia-based catalytic composition of claim 16, wherein the primary promoter comprises molybdenum oxide present in an amount to achieve a mole ratio of molybdenum to vanadium of about 0.5:1 to about 20:1.

20. The vanadia-based catalytic composition of claim 16, wherein the molybdenum is present in an amount to achieve a mole ratio of molybdenum to vanadium in the range of from about 1:1 to about 10:1.

21. The vanadia-based catalytic composition of claim 16, further comprising a volatility inhibitor is selected from the group consisting of zirconium oxide, tin oxide, manganese oxide, lanthanum oxide, cobalt oxide, niobium oxide, zinc oxide, bismuth oxide, aluminum oxide, nickel oxide, chromium oxide, iron oxide, yttrium oxide, gallium oxide, germanium oxide, indium oxide and combinations thereof.

22. The vanadia-based catalytic composition of claim 21, wherein the volatility inhibitor is present in an amount to achieve a mole ratio of volatility inhibitor to molybdenum in the range of from about 0.05:1 to about 5:1.

23. The vanadia-based catalytic composition of claim 22, wherein the volatility inhibitor is selected from the group consisting of zirconium oxide, tin oxide, and combinations thereof.

24. The vanadia-based catalytic composition of claim 22, wherein the volatility inhibitor is zirconium oxide.

25. The vanadia-based catalytic composition of claim 22, wherein the volatility inhibitor and the phosphate are present at levels balanced to achieve an optimum combination of NOₓ conversion and SO₂ oxidation.

26. The vanadia-based catalytic composition of claim 22, wherein the volatility inhibitor is selected from the group consisting of zirconium oxide, tin oxide, and combinations thereof, the vanadia-based catalytic composition further comprising a transition or main group metal selected from the group consisting of lanthanum, cobalt, zinc and combinations thereof.

27. A process for making a vanadia-based catalytic composition for reduction of nitrogen oxides, the process comprising the following steps:
(a) providing an aqueous slurry of titania;
(b) exposing the aqueous slurry of titania to a soluble promoter compound selected from the group consisting of tungsten, molybdenum, and combinations thereof, and adjusting the pH to a value to yield a hydrolyzed promoter-titania mixture;
(c) removing water from the hydrolyzed promoter-titania mixture from step (b) to produce promoter-titania mixture solids, and calcining the promoter-titania mixture solids to produce a support material;
(d) providing an aqueous solution of vanadium oxide;
(e) adding the support material from step (c) to the vanadium oxide solution to produce a product slurry;
(f) adding in either step (b) or step (e), a phosphate compound in sufficient quantity to achieve a mole ratio of phosphorus to tungsten plus molybdenum of about 0.2:1 or greater in the product slurry; and
(g) removing water from the product slurry from step (f) to produce product solids, and calcining the product solids to produce a vanadia-based catalytic composition for reduction of nitrogen oxides, the vanadia-based catalytic composition having a mole ratio of phosphorus to tungsten plus molybdenum of about 0.2:1 or greater.

28. The process of claim 27, wherein the soluble phosphate compound is added in sufficient quantity to achieve a mole ratio of phosphorus to promoter in the product slurry in the range of from about 0.2:1 to about 4:1.

29. The process of claim 27, wherein the soluble promoter is a soluble tungsten compound.

30. The process of claim 27, wherein the soluble promoter compound is a soluble molybdenum compound.

31. The process of claim 30, wherein the phosphate compound is added in sufficient quantity to achieve a mole ratio of phosphorus to molybdenum in the product slurry in the range of from about 0.2:1 to about 4:1.

32. The process of claim 30, wherein the phosphate compound is added to the product slurry in step (e), after addition of soluble molybdenum compound and prior to removing water in step (g).

33. The process of claim 30, wherein the soluble promoter compound is added in sufficient quantity to achieve a mole ratio of molybdenum to vanadium in the range of from about 0.5:1 to about 20:1 in the vanadia-based catalytic composition.

34. The process of claim 30, wherein the soluble promoter compound is added in sufficient quantity to achieve a mole ratio of molybdenum to vanadium in the range of from about 1:1 to about 10:1 in the vanadia-based catalytic composition.

35. The process of claim 30, further comprising exposing the aqueous slurry of titania to a soluble volatility inhibitor compound in step (a), wherein the soluble volatility inhibitor compound is selected from the group consisting of soluble zirconium compounds, soluble tin compounds, soluble manganese compounds, soluble lanthanum compounds, soluble cobalt compounds, soluble niobium compounds, soluble zinc compounds, soluble bismuth compounds, soluble aluminum compounds, soluble nickel compounds, soluble chromium compounds, soluble iron compounds, soluble yttrium compounds, soluble gallium compounds, soluble germanium compounds, soluble indium compounds, and mixtures thereof.

36. The process of 35, wherein the soluble volatility inhibitor compound is selected from the group consisting of soluble tin compounds, soluble zirconium compounds, and mixtures thereof.

37. The process of claim 36, further comprising adding a transition or main group metal in either step (b) or step (e), the transition or main group metal selected from the group consisting of lanthanum, cobalt, zinc, copper, niobium, silver, bismuth, zirconium, aluminum, nickel, chromium, iron, yttrium, gallium, germanium, indium, and combinations thereof.

38. The process of claim 35, wherein the soluble volatility inhibitor is added as an aqueous solution.

39. The process of claim 35, wherein the volatility inhibitor is present in an amount to achieve a mole ratio of volatility inhibitor to molybdenum in the range of from about 0.05:1 to about 5:1 in the vanadia-based catalytic composition.

40. A process for making a titania-based catalyst support material, the process comprising the following steps:
(a) providing an aqueous slurry of titania;
(b) exposing the aqueous slurry of titania to a soluble promoter compound selected from the group consisting of tungsten, molybdenum, and combinations thereof, and to a phosphate compound in sufficient quantity to achieve a mole ratio of phosphorus to tungsten plus molybdenum of about 0.2:1 or greater, adjusting the pH to a value to yield a phosphated promoter-titania mixture; and
(c) removing water from the phosphated promoter-titania mixture from step (b) to produce promoter-titania mixture solids, and calcining the promoter-titania mixture solids to produce a titania-based catalyst support material having a mole ratio of phosphorus to tungsten plus molybdenum of about 0.2:1 or greater.

41. The process of claim 40, wherein the soluble phosphate compound is added in sufficient quantity to achieve a mole ratio of phosphorus to promoter in the titania-based catalyst support material in the range of from about 0.2:1 to about 4:1.

42. The process of claim 40, wherein the soluble promoter is a soluble tungsten compound.

43. The process of claim 40, wherein the soluble promoter compound is a soluble molybdenum compound.

44. The process of claim 43, wherein the phosphate compound is added in sufficient quantity to achieve a mole ratio of phosphorus to molybdenum in the titania-based catalyst support material in the range of from about 0.2:1 to about 4:1.

45. The process of claim 43, further comprising exposing the phosphated promoter-titania mixture to a soluble volatility inhibitor compound in step (a), wherein the soluble volatility inhibitor compound is selected from the group consisting of soluble zirconium compounds, soluble tin compounds, soluble manganese compounds, soluble lanthanum compounds, soluble cobalt compounds, soluble niobium compounds, soluble zinc compounds, soluble bismuth compounds, soluble aluminum compounds, soluble nickel compounds, soluble chromium compounds, soluble iron compounds, soluble yttrium compounds, soluble gallium compounds, soluble germanium compounds, soluble indium compounds, and mixtures thereof.

46. The process of 45, wherein the soluble volatility inhibitor compound is selected from the group consisting of soluble tin compounds, soluble zirconium compounds, and mixtures thereof.

47. The process of claim 46, further comprising adding a transition or main group metal in either step (b) or step (e), the transition or main group metal selected from the group consisting of lanthanum, cobalt, zinc, copper, niobium, silver, bismuth, aluminum, nickel, chromium, iron, yttrium, gallium, germanium, indium, and combinations thereof.

48. The process of claim 45, wherein the soluble volatility inhibitor is added as an aqueous solution.

49. The process of claim 45, wherein the volatility inhibitor is present in an amount to achieve a mole ratio of volatility inhibitor to molybdenum in the range of from about 0.05:1 to about 5:1 in the titania-based catalyst support material.

50. A method of reducing NOₓ compounds in a gas or liquid comprising contacting the gas or liquid with a vanadia-based catalytic composition for a time sufficient to reduce the level of NOₓ compounds in said gas or liquid, wherein the vanadia-based catalytic composition comprises a titania-based support material; vanadia deposited on the titania-based support material; a primary promoter comprising tungsten oxide, molybdenum oxide, or a combination of tungsten oxide and molybdenum oxide; and an amount of phosphate to achieve a mole ratio of phosphorus to tungsten plus molybdenum of about 0.2:1 or greater.

51. The method of claim 50, wherein the primary promoter comprises molybdenum oxide, and wherein the vanadia-based catalytic composition further comprises a volatility inhibitor selected from the group consisting of zirconium oxide, tin oxide, manganese oxide, lanthanum oxide, cobalt oxide, niobium oxide, zinc oxide, bismuth oxide, aluminum oxide, nickel oxide, chromium oxide, iron oxide, yttrium oxide, gallium oxide, germanium oxide, indium oxide, and combinations thereof, the volatility inhibitor present in an amount to achieve a mole ratio of volatility inhibitor to molybdenum in the range of from about 0.05:1 to about 5:1.
